(19) United States
(12) Patent Application Publication
(10) Pub. No.: US 2020/0340433 A1
(43) Pub. Date: Oct. 29, 2020

(54) AIR INTAKE DUCT FOR INTERNAL COMBUSTION ENGINE

(71) Applicant: TOYOTA BOSHOKU KABUSHIKI KAISHA, Aichi-ken (JP)

(72) Inventor: Ryusuke KIMURA, Ichinomiya-shi (JP)

(73) Assignee: TOYOTA BOSHOKU KABUSHIKI KAISHA, Aichi-ken (JP)

(21) Appl. No.: 16/962,717

(22) PCT Filed: Jan. 22, 2019
(86) PCT No.: PCT/JP2019/001876

§ 371 Date: Jul. 16, 2020

(30) Foreign Application Priority Data
Jan. 25, 2018 (JP) 2018-010720

(51) Int. Cl. F02M 35/10

(52) U.S. Cl. CPC F02M 35/10091; F02M 35/10314

(57) ABSTRACT

This air intake duct for an internal combustion engine is provided with a duct body having a cylindrical sidewall. At least part of the sidewall is provided with a support section which is formed from an air permeable material which allows air to flow between the inside and outside of the sidewall and which supports the portions of the sidewall, which face each other.

### TECHNICAL FIELD

The present invention relates to an intake duct for an internal combustion engine.

### BACKGROUND ART

A typical intake duct for an onboard internal combustion engine includes an intake end arranged between the hood of the vehicle and a vehicle component arranged below the hood (refer to, for example, Patent Document 1).

The intake end of the intake duct described in Patent Document 1 includes an intake upper wall and an intake lower wall. The intake upper wall and the intake lower wall are both made of a plastic material.

The intake lower wall includes a hollow first support bulged toward the intake upper wall.

The intake upper wall includes a second support. The second support has a plate shape projecting toward the first support. The second support includes a projecting end having a tip shape.

In such an intake duct, when intake negative pressure acts, the end of the first support and the end of the second support contact with each other to prevent the intake duct from being blocked.

### PRIOR ART DOCUMENTS

### Patent Documents

Patent Document 1: Japanese Laid-Open Patent Publication No. 2011-153530

### SUMMARY OF THE INVENTION

### Problems that the Invention is to Solve

In the intake duct described in Patent Document 1, intake air separates from the wall surfaces of the first support and the second support to produce vortices. The produced vortices may increase airflow resistance.

It is an objective of the present invention to provide an intake duct for an internal combustion engine that reduces airflow resistance.

### Means for Solving the Problem

An intake duct for an internal combustion engine that solves the above-described objective includes a duct body that includes a tubular side wall. At least part of the side wall is provided with a support made of a breathable material that lets air between an inside and an outside of the side wall, the support supporting opposing portions of the side wall.

In this structure, the support is made of a breathable material that lets air between the inside and the outside of the side wall. Thus, while the internal combustion engine is running, the negative pressure of intake air causes external air to be drawn through the support into the duct body.

Accordingly, boundary layers are formed in the vicinity of the wall surface of the support. Thus, smaller vortices are produced as compared with when the support is made of a non-breathable material such as a plastic article. This reduces pressure loss and limits airflow resistance.

### Effects of the Invention

In the present invention, airflow resistance is reduced.

### BRIEF DESCRIPTION OF THE DRAWINGS

FIG. 1 is a side view showing the entirety of an intake duct for an internal combustion engine according to an embodiment.

FIG. 2 is a cross-sectional view of the intake duct in the embodiment.

FIG. 3 is a plan view of the intake duct in the embodiment with the upstream annular member removed.

FIG. 4 is a plan view showing the halved bodies of the duct body in the intake duct in the embodiment.

FIG. 5 is a cross-sectional view showing the layered structure of the side wall of the duct body in the embodiment.

FIG. 6 is a cross-sectional view showing a support according to a modification.

FIG. 7 is a cross-sectional view showing a support according to another modification.

FIG. 8 is a cross-sectional view showing a support according to a further modification.

### MODES FOR CARRYING OUT THE INVENTION

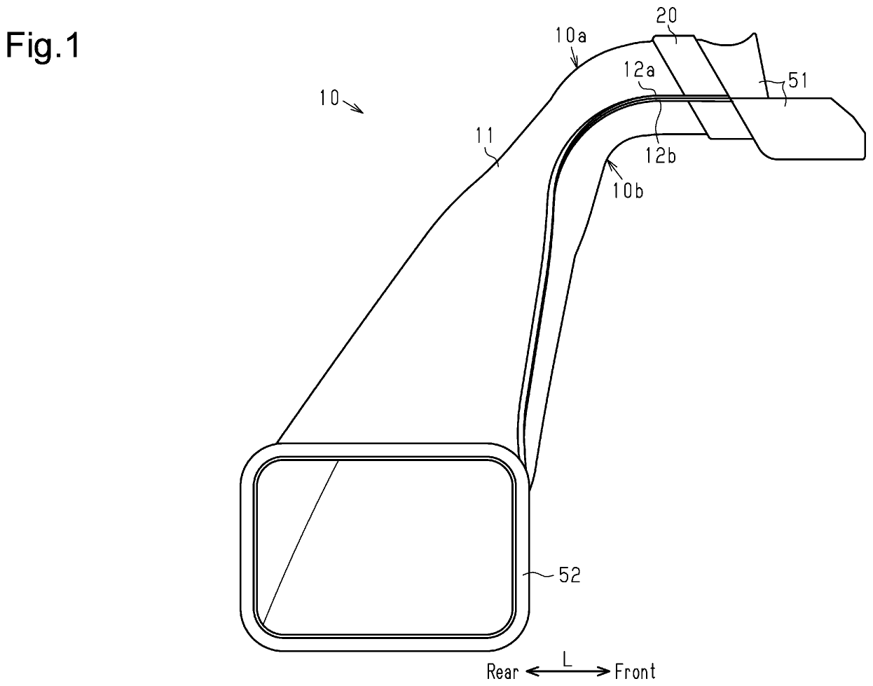

An intake duct for an internal combustion engine according to an embodiment will now be described with reference to FIGS. 1 to 5.

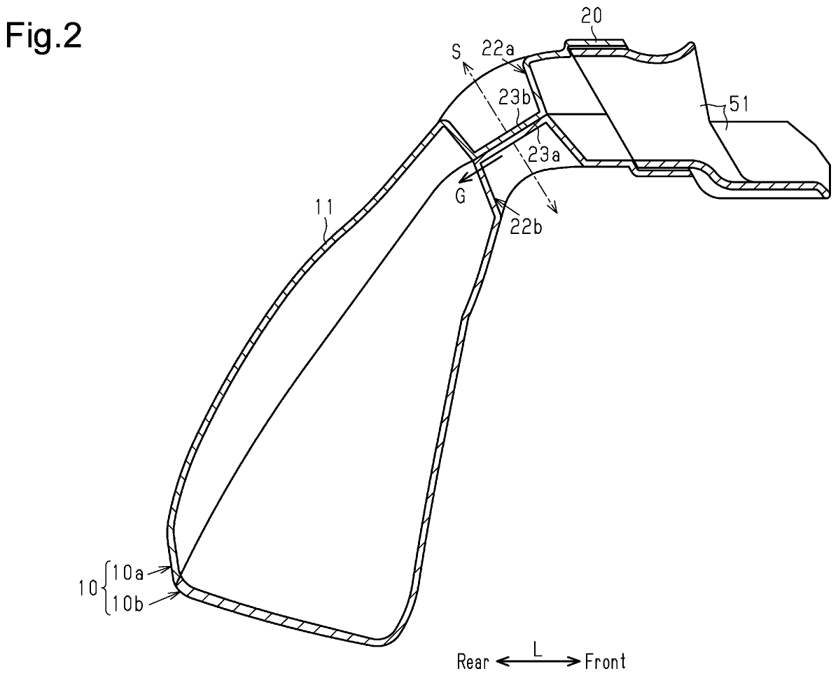

Referring to FIGS. 1 and 2, the intake duct configures an intake end of an intake passage of the onboard internal combustion engine.

In the following description, the front-rear direction of the vehicle is simply referred to as the front-rear direction L, and the upstream side and the downstream side in the flow direction of intake air in the intake duct are simply referred to as the upstream side and the downstream side, respectively.

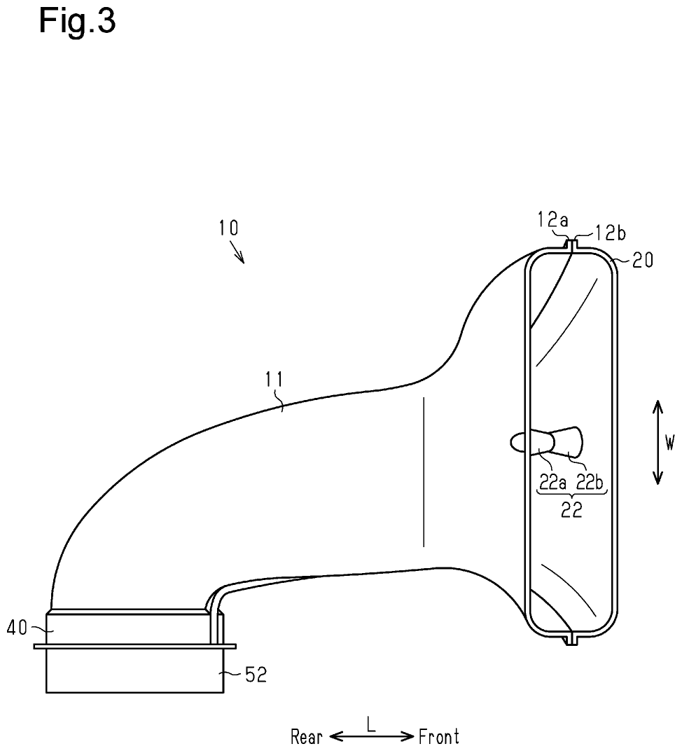

The intake duct includes a duct body 10 with a tubular side wall 11, which is formed by a fibrous molded body. The duct body 10 includes an inlet portion 20 that opens frontward in the front-rear direction L. As shown in FIG. 3, the duct body 10 extends rearward in the front-rear direction L from the inlet portion 20. The rear part of the duct body 10 is curved to extend downward and extend toward one side in a width direction W, and includes an outlet portion 40 that opens toward that side in the width direction W.

An upstream annular member 51, which is made of a hard plastic material, is attached to the inlet portion 20 using adhesive. The upstream annular member 51 is attached to a structural body (not shown) of the vehicle, such as a radiator support, by an attachment portion (not shown) on the upstream annular member 51.

A downstream annular member 52, which is made of a hard plastic material, is attached to the outlet portion 40 using adhesive. The downstream annular member 52 is connected to the inlet (not shown) of an air cleaner.

As shown in FIGS. 1 to 4, the side wall 11 of the duct body 10 includes a first halved body 10a and a second halved body 10b. The first halved body 10a has the form of a halved tube. The second halved body 10b has the form of a halved tube and is located downward from the first halved body 10a.

The opposite ends of the first halved body 10a in a peripheral direction are provided with joints 12a projecting outward.

The opposite ends of the second halved body 10b in the peripheral direction are provided with joints 12b projecting outward.

The joints 12a of the first halved body 10a and the joints 12b of the second halved body 10b are joined to each other to form the side wall 11, which is tubular.

As shown in FIGS. 2 to 4, the bent portion of the first halved body 10a includes a first support 22a projecting toward the second halved body 10b. The bent portion of the second halved body 10b includes a second support 22b projecting toward the first halved body 10a. The first support 22a includes a projecting end 23a and tapers toward the projecting end 23a. The second support 22b includes a projecting end 23b and tapers toward the projecting end 23b. The projecting end 23a of the first support 22a and the projecting end 23b of the second support 22b are joined to each other.

The first support 22a and the second support 22b configure a support 22 that supports the opposing portions of the first halved body 10a and the second halved body 10b.

In the following description, the projection direction of the first support 22a and the second support 22b (i.e., the direction in which the support 22 supports the side wall 11) is referred to as the support direction S.

As shown in FIG. 3, the cross-section of the passage in the inlet portion 20 has a rectangular shape that is longer in the width direction W than in the up-down direction (up-down direction in FIG. 1).

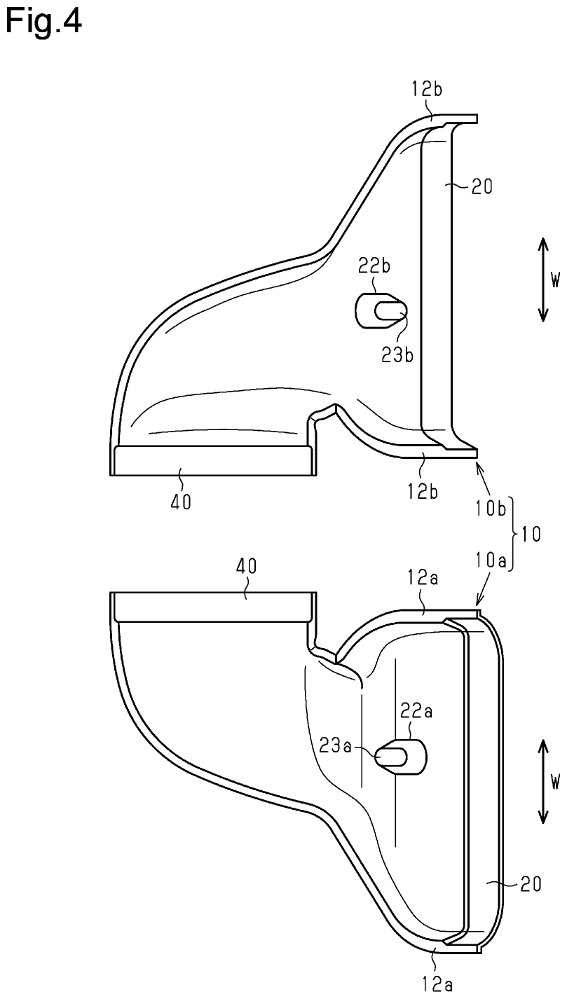

As shown in FIG. 4, the supports 22a and 22b each have an oval cross-sectional shape that is longer in the extending direction of the duct body 10 in the vicinity of the supports 22a and 22b, that is, an intake air flow direction G (refer to FIG. 2), than in the width direction W.

The width direction W is orthogonal to both the support direction S and the intake air flow direction G, which is in the vicinity of the support 22. The width direction W corresponds to a width direction in the present invention.

The structure of the fibrous molded body that configures the side wall 11 of the duct body 10 will now be described.

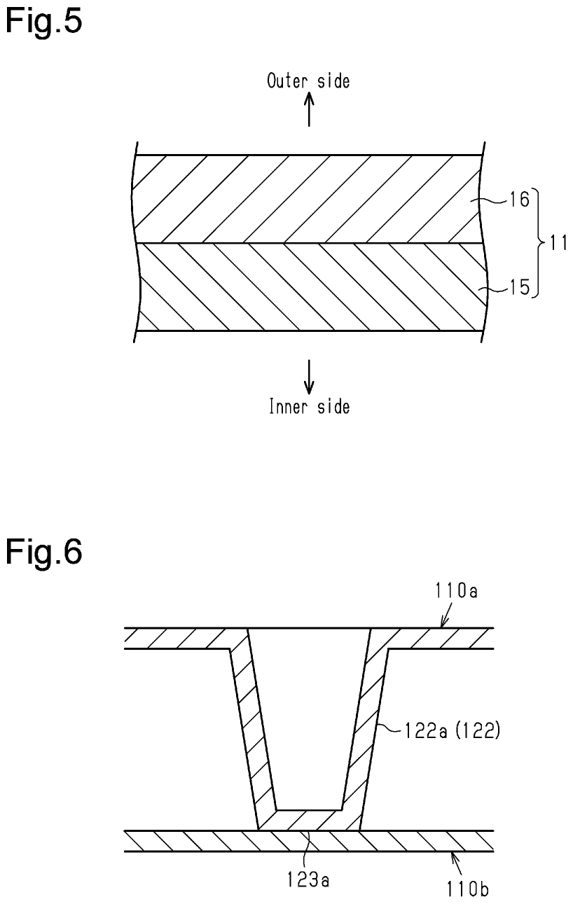

As shown in FIG. 5, the halved bodies 10a and 10b of the side wall 11 include an inner layer 15 and an outer layer 16. The inner layer 15 configures the inner surface of the duct body 10. The outer layer 16 is fixed to the outer surface of the inner layer 15 and configures the outer surface of the duct body 10.

The fibrous molded body that configures each of the inner layer 15 and the outer layer 16 is made of nonwoven fabric of a PET fiber and nonwoven fabric of known core-sheath composite fibers each including, for example, a core (not shown) made of polyethylene terephthalate (PET) and a sheath (not shown) made of denatured PET having a lower melting point than the PET fiber. The denatured PET, which serves as the sheath of the composite fibers, functions as a binder that binds the fibers to each other.

The mixing ratio of the modified PET is preferably between 30 to 70% inclusive. In the present embodiment, the mixture percentage of denatured PET is 50%.

Such a composite fiber may also include polypropylene (PP) having a lower melting point than PET.

The weight per unit area of the fibrous molded body of each of the inner layer 15 and the outer layer 16 is preferably 250 g/m² to 750 g/m². In the present embodiment, the weight per unit area of the fibrous molded body of each of the inner layer 15 and the outer layer 16 is 400 g/m².

The halved bodies 10a and 10b are each formed by thermally compressing (thermally pressing) the above-described nonwoven sheet having a predetermined thickness of, for example, 30 to 100 mm.

The structure of each part of the duct body 10 (halved bodies 10a and 10b) will now be described in detail.

The inlet portion 20 and the outlet portion 40 of the duct body 10 and the joints 12a and 12b of the halved bodies 10a and 10b are high-compression portions. The portions of the duct body 10 other than the inlet portion 20, the outlet portion 40, and the joints 12a and 12b are breathable low-compression portions that have undergone thermo-compression molding at a lower compressibility than the high-compression portions. That is, the first support 22a and the second support 22b are breathable low-compression portions.

The high-compression portions have a breathability (JIS L 1096 A-Method (Frazier Method)) of approximately 0 cm³/cm²·s. Further, it is preferable that the high-compression portions have a thickness of 0.5 to 1.5 mm. In the present embodiment, the high-compression portions have a thickness of 0.7 mm.

The low-compression portion has a breathability of approximately 3 cm³/cm²·s. Further, it is preferable that the low-compression portion have a thickness of 0.8 to 3.0 mm. In the present embodiment, the low-compression portion has a thickness of 1.0 mm.

The intake duct for the internal combustion engine according to the present embodiment described above has the following advantages.

(1) The side wall 11 of the duct body 10 includes the support 22. The support 22 is made of a breathable material (fibrous molded body) that lets air between the inside and the outside of the side wall 11. The support 22 supports the opposing portions of the side wall 11.

In this structure, the support 22 is made of a breathable material that lets air between the inside and the outside of the side wall 11. Thus, while the internal combustion engine is running, the negative pressure of intake air causes external air to be drawn through the support 22 into the duct body 10.

Accordingly, boundary layers are formed in the vicinity of the wall surface of the support 22. Thus, smaller vortices are produced as compared with when the support 22 is made of a non-breathable material such as a plastic article. This reduces pressure loss and limits airflow resistance.

(2) The entire side wall 11 is formed by a fibrous molded body.

In such a structure, the generation of standing waves of intake noise is limited by the entire side wall 11 absorbing some of the pressure (noise pressure) of intake noise in the duct body 10. This reduces intake noise.

Additionally, the above-described structure reduces the number of components of the intake duct.

(3) The side wall 11 includes the first halved body 10a and the second halved body 10b. The first halved body 10a includes the first support 22a projecting toward the second halved body 10b. The second halved body 10b includes the second support 22b projecting toward the first halved body 10a. The projecting end 23a of the first support 22a and the projecting end 23b of the second support 22b are joined to each other. The support 22 is configured by the first support 22a and the second support 22b.

In such a structure, the support 22 includes the first support 22a and the second support 22b that respectively project from the first halved body 10a and the second halved body 10b of the side wall 11. Thus, the projection lengths of the supports 22a and 22b are reduced. This facilitates the formation of the support 22 while configuring the side wall 11 by the fibrous molded body.

(4) The support 22 has an oval cross-sectional shape that is longer in the intake air flow direction G in the vicinity of the support 22 than in the width direction W.

Such a structure effectively limits increases in the airflow resistance that result from the arrangement of the support 22.

Modifications

The above-described embodiment may be modified as follows.

In the above-described embodiment, the intake duct including a single support 22 is shown as an example. Instead, multiple supports may be arranged so as to be spaced apart from one another in the extending direction of the duct body.

In such a structure, the supports increase the rigidity of the duct body 10. This further limits the deformation of the intake duct. Additionally, in the above-described structure, increases in the airflow resistance that result from the arrangement of the supports are limited by the above-described advantage (1), which is achieved by drawing air through the supports.

The shape of the duct body may be changed. For example, the duct body may be shaped to extend straight.

For example, as shown in FIG. 6, a projecting end 123a of a first support 122a of a first halved body 110a may be joined to the inner surface of a second halved body 110b. In this case, only the first support 122a configures a support 122. Thus, a second support of the second halved body 110b can be omitted.

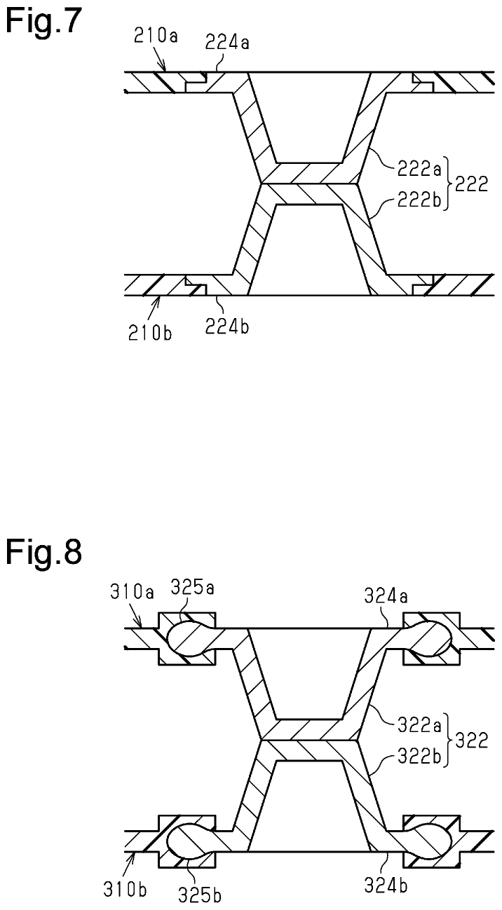

Referring to FIG. 7, halved bodies 210a and 210b of the duct body may be made of a hard plastic material, and parts of the first and second halved bodies 210a and 210b may be respectively provided with tubular support members 222a and 222b of a support 222. The support member 222a includes a basal end 224a projecting outward from the support member 222a. In the same manner, the support member 222b includes a basal end 224b projecting outward from the support member 222b. The side wall of the first halved body 210a and the basal end 224a of the support member 222a are joined to each other such that they are overlapped with each other in the thickness direction of the side wall. In the same manner, the side wall of the second halved body 210b and the basal end 224b of the support member 222b are joined to each other such that they are overlapped with each other in the thickness direction of the side wall. In this case, the support members 222a and 222b simply need to be molded in advance, and the halved bodies 210a and 210b simply need to be injection-molded with the support members 222a and 222b inserted into the molds.

Alternatively, as shown in FIG. 8, peripheral portions 325a and 325b of basal ends 324a and 324b of support members 322a and 322b of a support 322 may be formed at a lower compressibility than other portions. In this case, a first halved body 310a can be injection-molded such that the peripheral portion 325a is held by the first halved body 310a in the thickness direction of the side wall. In the same manner, a second halved body 310b can be injection-molded such that the peripheral portion 325b is held by the second halved body 310b in the thickness direction of the side wall. In such a structure, the joining strength is increased by the anchoring effect working when molten resin fills the gaps between the fibers of the peripheral portions 325a and 325b.

In the above-described embodiment, the support 22 has an oval cross-sectional shape that is longer in the intake air flow direction G in the vicinity of the support 22 than in the width direction W. Instead, a support may have a cross-sectional shape of, for example, a perfect circle, a quadrilateral, or a rhombus.

### DESCRIPTION OF THE REFERENCE NUMERALS

10) Duct Body; 10a, 110a, 210a, 310a) First Halved Body; 10b, 110b, 210b, 310b) Second Halved Body; 11) Side Wall; 12a, 12b) Joint; 15) Inner Layer; 16) Outer Layer; 20) Inlet Portion; 22, 122, 222, 322) Support; 22a, 122a) First Support; 22b) Second Support; 23a, 23b, 123a) Projecting End; 40) Outlet Portion; 51) Upstream Annular Member; 52) Downstream Annular Member; 222a, 222b, 322a, 322b) Support Member; 224a, 224b, 324a, 324b) Basal End; 325a, 325b) Peripheral Portion

1. An intake duct for an internal combustion engine, the intake duct comprising a duct body that includes a tubular side wall,
wherein at least part of the side wall is provided with a support made of a breathable material that lets air between an inside and an outside of the side wall, the support supporting opposing portions of the side wall.

2. The intake duct according to claim 1, wherein the side wall is entirely formed by a fibrous molded body.

3. The intake duct according to claim 2, wherein
the side wall includes a first halved body and a second halved body,
the first halved body includes a first support projecting toward the second halved body,
the second halved body includes a second support projecting toward the first halved body,
the first support and the second support respectively include projecting ends that are joined to each other, and
the support is configured by the first support and the second support.

4. The intake duct according to claim 1, wherein
a direction that is orthogonal to both a support direction in which the support supports the side wall and an intake air flow direction in a vicinity of the support is referred to as a width direction, and
the support has an oval cross-sectional shape that is longer in the intake air flow direction than in the width direction.
